(19) United States
(12) Patent Application Publication
(10) Pub. No.: US 2026/0359356 A1
(43) Pub. Date: Nov. 12, 2026

(54) SYSTEMS AND METHODS USING COMPUTER-IMPLEMENTED VISION PLATFORMS FOR REAL-TIME VIDEO INDEXING AND SEARCH

(71) Applicants: Christopher R. BRINTON, Leesburg, VA (US); Matthew R. BRINTON, Provo, UT (US); Keith C. RUDD, Weston, ID (US)

(72) Inventors: Christopher R. BRINTON, Leesburg, VA (US); Matthew R. BRINTON, Provo, UT (US); Keith C. RUDD, Weston, ID (US)

(21) Appl. No.: 19/670,207

(22) Filed: May 7, 2026

Related U.S. Application Data
(60) Provisional application No. 63/802,428, filed on May 8, 2025.

(51) Int. Cl. G06F 16/783; G06F 16/71; G06V 20/52

(52) U.S. Cl. CPC G06F 16/786; G06F 16/71; G06V 20/52

(57) ABSTRACT

A system and method are described that provide a computer-implemented vision platform for real-time video indexing, retrieval, and alerting, that transforms incoming surveillance video into a selectively stored semantic representation that supports efficient search across one or more camera feeds based on an ability to limitedly and selectively identify and store visual content that is determined to be sufficiently distinct from an expected background state of a scene under surveillance.

This application claims the benefit of U.S. Provisional Patent Application No. 63/802,428, entitled “Computer-Implemented Vision Platform and Method for Real-Time Video Indexing And Search,” filed in the U.S. Patent and Trademark Office on May 8, 2025, the disclosure of which is hereby incorporated by reference herein in its entirety.

### BACKGROUND

### 1. Field of the Disclosure

This disclosure is directed to exemplary embodiments of systems, methods, applications, techniques and schemes for executing a computer-implemented vision surveillance platform that provides for real-time video indexing, retrieval and alerting, particularly employing a selective semantic indexing mechanism that is advantageously used to intelligently determine only those select, non-redundant portions of live video that should be preserved in a searchable representation.

### 2. Description of the Related Art

Traditional or legacy surveillance systems that implement storage or archive of live video for later retrieval may generally be deemed as falling into three fairly broad categories according to the following attributes:
(1) Legacy metadata and fixed-detector systems, which typically index content according to that which predefined models, labels, attributes, or event classes are designed to recognize;
(2) Exhaustive embedding and general text-to-video search systems, which typically embed and index broad portions of video, including every frame or volumes of sampled frames, to support open-vocabulary retrieval; and
(3) Rule-based or motion-triggered surveillance systems, which focus on motion events, predefined primitives, or operator-defined event conditions, thereby typically remaining limited to sets of conditions that were specified in advance.
   Each of these broad categories, or general architectural classes, of existing surveillance and video-search technologies, addresses a particularized and often narrow need while including certain incumbent underlying shortfalls.

Legacy metadata-driven and fixed-detector systems index surveillance footage primarily through structured outputs such as object detections, labels, attributes, event tags, or other human-readable metadata generated by predefined models or rules. An advantage of such systems may reside in operational familiarity and straightforward filtering over known categories. Against that, however, such systems tend to be overly constrained by fixed label taxonomies, often rendering these systems “brittle” outside their expressly-trained categories, thereby requiring retraining, cumbersome rule authoring, or manual taxonomy expansion before new concepts can be reliably searched.

Exhaustive embedding or general text-to-video search systems tend to be comparatively unwieldy as not adaptable to limited storage architectures in that these systems commonly generate embeddings for all frames, many sampled frames, or otherwise broad portions of a video corpus and then allow natural-language or similarity-based retrieval across that comprehensively indexed set. While such architecture may perhaps advantageously support open-vocabulary search, tremendous drawbacks are encountered in the surveillance context in that these systema frequently, if not always, incur comparatively high storage, indexing, and search burdens based on their incumbent need to preserve large quantities of repetitive or low-value visual content. Moreover, these systems often lack a surveillance-specific novelty gate for determining whether newly-observed content is sufficiently distinct from ordinary scene states so as to justify inclusion in the searchable corpus.

Rule-based and motion-triggered surveillance systems typically monitor for motion, predefined event primitives, object-class triggers, or operator-authored rules and then generate alerts, clips, or logs when a specified condition is met. While this approach may be limitedly useful for conventional monitoring and alarm workflows based on being operationally direct and/or computationally efficient, such systems are definitionally incapable of creating a rich, open-ended semantic representation of scene content, and otherwise generally do not support broad natural-language retrieval over previously unspecified objects, persons, scenes, or activities.

### SUMMARY

Against the above-enumerated restrictions and limitations in traditional or legacy surveillance systems, it may be advantageous to provide innovative systems, methods, applications, techniques and/or schemes that particularly depart from all three categories in important and unforeseen ways.

In embodiments, the disclosed systems, methods, applications, techniques and schemes (hereinafter generally referred to as “disclosed schemes”) may efficiently and effectively use motion and/or semantic deviation from a rolling scene (background) embedding to determine those elements of content that should be selectively extracted, indexed and retained in a searchable semantic index. The disclosed schemes may allow the surveillance systems to remain storage-efficient while fully supporting open-vocabulary retrieval and alerting over surveillance content, rather than relying on, for example, a fixed metadata taxonomy, an exhaustive semantic persistence, or a pre-defined set of motion and rule triggers.

Exemplary embodiments of the disclosed schemes may provide an innovative selective indexing mechanism that may be differentiated by building a comparatively sparse semantic memory of surveillance activity that may store only surveillance regions that are meaningfully different from a learned background state of a particular scene under surveillance, allowing the disclosed schemes to remain efficient while preserving flexibility in what can later be searched, reviewed, or otherwise used to trigger alerts.

Exemplary embodiments are meaningfully remote from traditional or legacy surveillance systems in that, rather than storing every frame or relying only on predefined object labels, the disclosed schemes may be usable to uniquely: (a) parse or otherwise divide incoming video into regions; (b) compute visual-semantic embeddings for those regions; and (c) compare new embeddings against a rolling background of embeddings previously archived for the corresponding regions.

In embodiments, for example, a particular region may be uniquely indexed when motion and/or semantic deviation indicates, or determines, that the region is sufficiently dissimilar from its background baseline, as may be measured by a configurable similarity threshold. In this manner, the disclosed schemes may allow the retention of semantically meaningful changes while avoiding redundant storage of static or repetitive content.

Exemplary embodiments of the systems and methods according to this disclosure may uniquely combine three capabilities in a unified surveillance architecture in an unforeseen scheme for: (1) semantic-selective indexing, (2) open-vocabulary retrieval, and (3) real-time multi-camera scalability.

In embodiments, at least one core differentiator is that the disclosed schemes do not merely accept natural-language queries, but rather the schemes determine what should be remembered by comparing incoming scene regions against rolling semantic scene (background) baselines and indexing only sufficiently dissimilar content. Such a system design may move surveillance beyond brittle label-based search, and beyond brute-force archival storage, by creating a more efficient and adaptable system for monitoring, review, and alert generation.

As will be described in specific detail below, the disclosed embodiments may provide a computer-implemented vision platform for real-time video indexing, retrieval and alerting. In embodiments, the disclosed schemes may transform incoming surveillance video into a selectively stored semantic representation that supports efficient search across one or more camera feeds.

These and other features, and advantages, of the disclosed schemes are described in, or apparent from, the following detailed description of various exemplary embodiments.

### BRIEF DESCRIPTION OF THE DRAWINGS

Various exemplary embodiments of the disclosed unique schemes for providing a computer-implemented vision platform for real-time video indexing, retrieval and alerting, will be described, in detail, with reference to the following drawings, in which:

FIG. 1 schematically illustrates an exemplary embodiment of a system that may be usable to effect elements of the unique scheme for real-time video indexing, retrieval and alerting according this disclosure;

FIG. 2 schematically illustrates a collection of individual nodes or processes that may be available to functionally implement the variously illustrated exemplary functions of a video analysis/extraction unit in support of the overall automated scheme according to this disclosure;

FIG. 3 schematically illustrates an exemplary embodiment of a flowchart for a method that may be usable to effect elements of performing live ingest and real-time selective video indexing according this disclosure; and

FIG. 4 schematically illustrates an exemplary embodiment of a flowchart for a method that may be usable to effect elements of performing user-initiated query, retrieval and alerting according this disclosure.

### DETAILED DESCRIPTION OF EMBODIMENTS

The disclosed unique schemes may provide a computer-implemented vision platform for real-time video indexing, retrieval and alerting. In embodiments, the disclosed schemes may be usable to transform all or portions of incoming surveillance video into selectively stored semantic representations that fully yet efficiently support search of substantially all incoming surveillance information across one or more camera feeds. Rather than indexing every frame uniformly, or relying solely on predefined object labels, the disclosed schemes may uniquely identify and limitedly store visual content that is deemed to be sufficiently distinct from an expected background state of a particular scene under surveillance.

The disclosed schemes will be described as being particularly adaptable to individual and multiple camera scene surveillance systems and implementations. Reference will be made to exemplary embodiments described and depicted in this disclosure having certain system architectural elements with an objective of broad adaptation in all manner of video surveillance systems and implementations. Such references should not be interpreted as specifically limiting the disclosed schemes to any specific configuration. The descriptions and the associated references are intended to provide a particular set of parameters adapted to address a particular real-world use case in which the schemes according to this disclosure may be individually or collectively beneficially adapted for use. These references are intended to be illustrative only, and should not be considered as limiting the disclosed schemes to any certain embodiment, application, operational scenario or use case.

Exemplary embodiments may be beneficially adapted to address known shortfalls in related art systems, such as those identified above, by including one or more of the following as key innovative and differentiating elements:
Primary indexed unit—Using selected regions, chips, frames or clips determined by semantic and/or motion gating;
Indexing strategy—Using selective semantic indexing based on deviation from rolling background baselines;
Handling of redundancy—Suppressing repetitive content by comparing new content to a per-region semantic baseline;
Core representation—Linking visual-semantic embeddings to source video and metadata;
Query mode—Using Natural language over selectively indexed semantic memory, which may also support alerts;
Predefined label taxonomy use—Reduced, or otherwise rendered optional;
Ability to handle previously unspecified concepts—Supported within a scope of the underlying semantic model and indexed corpus;
Key differentiation—Selective semantic gate using rolling background embeddings and configurable thresholds;
Storage burden—Reduced by storing only semantically significant content;
Alerting—Ability to employ saved semantic query conditions against indexed content;
Multi-camera operation—Providing shared or federated semantic index across multiple streams; and/or
Dependence on retraining—Can operate with pretrained models, but adaptation embodiments may be included.
   All of the above leads to a best characterization of the disclosed schemes over known systems as a sparse semantic memory for surveillance.

By way of non-limiting example, and because the indexed content is represented in a shared semantic embedding space, the disclosed schemes advantageously support, among others, open-vocabulary natural-language retrieval over the selectively stored video representation. According to the disclosed schemes, a user, for example, may describe an object, person, scene, activity or the like in ordinary language, and that description may be mapped into the same semantic space used for indexed video regions. Matching results may then be retrieved by similarity search against this selectively indexed embedding corpus, rather than against an exhaustively stored video archive, or a fixed library of labels. In this manner, the disclosed schemes may enable flexible retrieval of previously unspecified concepts while keeping the focus on the integrated system, i.e., selective semantic indexing coupled to natural-language access over the resulting sparse surveillance memory.

In embodiments, the disclosed schemes may be designed to support real-time, multi-camera deployment. Video ingestion, region extraction, embedding generation, baseline updating, sparse indexing, query processing, and alert delivery may be modularized across multiple streams while maintaining linkage to source clips, timestamps, camera identifiers, and alert definitions. Such an architecture may support each of interactive investigation and persistent alerting workflows, individually or in combination, without requiring the exhaustive indexing of all, or even substantially all, incoming video.

Exemplary embodiments may include combinations of the following component capabilities:
Semantic embeddings for frames, regions, or objects—The disclosed schemes may employ a pretrained vision-language model, such as OpenCLIP, to generate high-dimensional semantic embeddings for image data extracted from video frames. These embeddings may be generated for full frames, overlapping regions, image chips, object crops, segmented foreground regions, or combinations thereof. Instead of storing only raw video or simple tags, the disclosed schemes may advantageously represent visual content as vectors in an embedding space suitable for comparison, indexing, retrieval, and alerting;
Selective indexing based on motion and semantic deviation—The disclosed schemes need not index every frame or region uniformly. In embodiments, each incoming frame may be divided into multiple overlapping regions of varying sizes so that localized changes in scene content can be evaluated independently in an efficient and effective manner. Decisions to store and index a frame, region, or image chip may be based on one or both of physical motion and semantic deviation from a “known” background state. Motion may be detected using pixel differencing, reverse principal component analysis or RPCA, or other foreground extraction techniques. Semantic deviation may be determined by comparing a newly generated embedding to a rolling background embedding for a corresponding region, such as a moving average or other baseline representation derived from prior observations. When newly observed content is determined to be sufficiently dissimilar from the background baseline, as measured by a configurable similarity threshold, the content may be selected for indexing. This approach reduces duplication of static or repetitive footage while preserving semantically meaningful changes;
Vector indexing and source linkage—Selected embeddings may be stored in a vector index, such as, for example, a Facebook AI Similarity Search or FAISS-based approximate nearest-neighbor database, to support efficient similarity search. Each stored embedding may remain linked to the source frame, source clip, timestamp, camera identifier, region identifier, and/or other metadata so that retrieved results can be traced back to the underlying video evidence or source;
Natural-language query and retrieval—Users may query the indexed video content using natural-language descriptions of objects, persons, scenes, or activities. A text query may be encoded into the same or a corresponding semantic space as the indexed visual embeddings, and the resulting query embedding may be compared against the indexed corpus using nearest-neighbor or other similarity search techniques. In embodiments, a background embedding may be established for each indexed region or region class, and query results may be re-scored by comparing candidate matches not only to the query embedding, but also to corresponding background embeddings. Similarity scores may be normalized, ranked, thresholded, or otherwise processed to estimate whether a candidate match is more likely to correspond to the requested content than to the ordinary background state of the scene. This may most advantageously allow open-vocabulary retrieval without requiring a predefined tag for each searchable concept;
Multi-camera and real-time operation—The disclosed scheme may be platform deployed across multiple camera feeds and may support near-real-time ingestion, embedding generation, selective indexing, retrieval, and alert evaluation. The architecture may be modular, with separate components for frame capture, region extraction, embedding computation, vector indexing, query processing, and result delivery. These components may be deployed on a camera, edge device, local appliance, central server, cloud environment, or combinations thereof.
Open-vocabulary operation with reduced retraining dependence—In embodiments, the disclosed schemes may operate using a pretrained model without requiring task-specific retraining whenever new object types, scenes, or descriptive queries arise. By relying on a broad semantic representation rather than a closed library of detector classes, the disclosed schemes can support retrieval of previously unspecified concepts within the representational scope of the underlying model. Optional calibration, adaptation, or fine-tuning may be used in embodiments, without requiring dependence on custom retraining for each new search target.

With the above individually-enumerated functional elements, and combinations thereof, the disclosed schemes may provide a surveillance architecture in which live video is transformed into a selectively indexed semantic representation that supports efficient search, retrieval, and alerting. A principal technical distinction is the use of motion and semantic deviation from a rolling background baseline to determine what content should be retained in a searchable index, thereby enabling open-vocabulary access to surveillance video without requiring exhaustive storage or a fixed metadata schema.

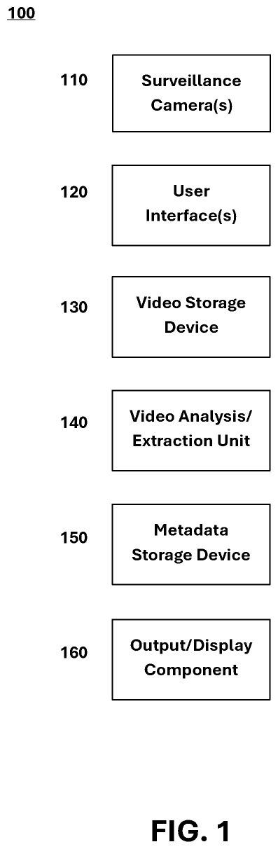

FIG. 1 schematically illustrates an exemplary embodiment of a system 100 that may be usable to effect elements of a unique scheme for real-time video indexing, retrieval and alerting according this disclosure.

As shown in FIG. 1, the exemplary system may reference one or more surveillance cameras 110 providing live video surveillance feeds for video extraction and analysis.

The exemplary system 100 may provide one or more user interfaces 120 via which an individual user, user-entity or organizational user may communicate with the exemplary system 100. Such communication may include user entry of system control and/or parameter information at, for example, a user workstation as a particular form of a user interface 120 for controlling the exemplary system 100. Such communication may otherwise include user queries sent to the exemplary system 100 from a user's mobile device as a separate form of a user interface 120 for sending queries to, and receiving responsive information from, the exemplary system 100.

The exemplary system 100 may include one or more data storage devices 130, 150. Individual, separate or combined data storage devices 130,150 may be segregated to include a video storage device 130 that may be specifically configured to store raw video and/or clips as received from one or more of the surveillance cameras 110, or from a video analysis/extraction unit 140. Separately, individual, separate or combined data storage devices 130,150 may be segregated to include a metadata storage device 150 that may be specifically configured to store vector index and metadata as received from the video analysis/extraction unit 140. Also, individual, separate or combined data storage devices 130,150 may be further segregated to include other data storage for system support. Such other data may include operating applications for carrying into effect the disclosed schemes and other stored information usable by the disclosed schemes including, for example, a library of background embeddings, including on a per region basis, and/or a library of alert definitions, including embeddings and thresholds.

The one or more data storage devices 130, 150 may be in a form of a local data storage unit or physical device, or may otherwise, for example, be in a form of a virtual or network storage location, including those residing “in the cloud.” No particular number or configuration for the one or more data storage devices 130,150, beyond the examples of the segregation schemes outlined above, is implied by the various descriptions of storing information/data, or referencing such stored information/data, in this disclosure.

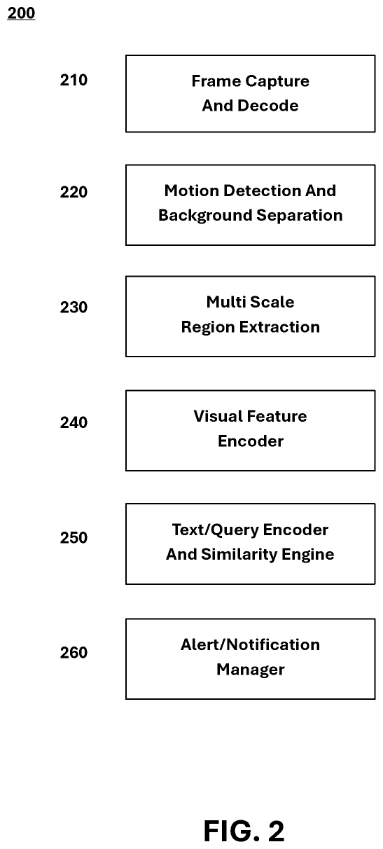

The exemplary system 100 may include one or more processing units or processors, such as a video analysis/extraction unit 140, by which the individual elements, schemes and processes described in this disclosure may be carried into effect. A reiteration of specific processing nodes and processes carried into effect by the exemplary video analysis/extraction unit 140 will be described in detail below with reference to the individual nodes and processes expressly depicted in FIG. 2.

The exemplary video analysis/extraction unit 140 may be in a form of a single local processor communicating in a networked or cloud-based infrastructure communicating with, for example, the surveillance cameras 110 and the other components of the exemplary system 100, or may be a network of processing elements each carrying out some subset of the overall processing backbone to carry into effect the details of the processing schemes and methods according to this disclosure.

The exemplary system 100 may provide one or more output/display component(s) 160 via which an individual user, user-entity or organizational user may review, or be provided, with indications of a status of, an operation of the system 100, and/or the processing executed thereby, including with the video analysis/extraction unit 140. These indications may be provided to the user in order that the user may monitor the execution of the automated scheme executed by the exemplary system 100, or may otherwise be provided with an output of a result of a query initiated by the user according to the disclosed schemes, or otherwise may be in a form of an alert generated according to the disclosed schemes.

The one or more output/display components 160 may be in a form of any conventional devices for displaying (for example, digital display screens) or outputting (for example, hard copy printers), or may encompass similar and evolving technologies for visually and/or audibly informing users. In embodiments, the one or more output/display components 160 may be combined with the one or more user interfaces 120 in one or more user interactive I/O devices, including a centrally located system control workstation, or a plurality of user mobile devices in communication with the exemplary system 100.

Communications between the individual elements of the exemplary system 100 particularly depicted in in FIG. 1 may include wired, wireless and/or virtual communications links between the individual elements. In instances, the communications may be unidirectional between combinations of the depicted elements, particularly from the surveillance cameras 110. Typically, however, the exemplary system 100 will execute the disclosed automated schemes via bi-directional communication between and among the other various depicted elements. Wireless communications may be by RF radio devices, optical interfaces, NFC devices and other wireless communicating devices according to RF, Wi-Fi, WiGig and other like or evolving communications protocols.

Moreover, it should be appreciated that the depiction in FIG. 1 should be viewed broadly in that no limitation is intended by this depiction to infer that the exemplary system 100 or any of the specifically depicted elements are particularly structured as individual and/or integral units. Rather, the various disclosed elements of the exemplary system 100 may be arranged in any combination of sub-systems as individual components or combinations of components, integral to a single unit, or external to, and in wired or wireless communication with the exemplary system 100. In other words, no specific configuration as an integral unit, or as a support unit, is to be implied by the depiction in FIG. 1. As indicated above, it is anticipated that the detailed components may be deployed on a camera, edge device, local appliance, central server, cloud environment, or combinations thereof.

Further, although depicted as individual units for ease of understanding of the details provided in this disclosure regarding the exemplary automated system 100, it should be understood that the described functions of any of the individually-depicted components may be undertaken, for example, by one or more separate processing units connected to, or in communication with, any others of the depicted elements.

FIG. 2 schematically illustrates a collection 200 of individual nodes or processes that may be available to functionally implement the variously illustrated exemplary functions of a video analysis/extraction unit (see element 140 in FIG. 1) in support of the overall automated scheme according to this disclosure.

In embodiments, a frame capture and decode node or process 210 may be provided to capture and decode multiple video streams coming from a plurality of surveillance cameras (see element 110 in FIG. 1). The live video stream(s) may be particularly decoded and normalized into frames.

In embodiments, a motion and background separation node or process 220 may be provided to detect motion and otherwise isolate a background as discrete elements for later determining semantic deltas in the newly-captured frames.

In embodiments, a multi-scale region extraction node or process 230 may be provided to parse the newly-captured frames into discrete regions of a size appropriate to support later determining semantic deltas in the newly-captured frames.

In embodiments, a visual feature encoder node or process 240 may be provided to index the newly-captured frames in which semantic deltas may be detected according to a common indexing scheme compatible with an encoded natural language query from a user.

In embodiments, a text/query encoder or similarity engine node or process 250 may be provided to receive a user natural language query and to encode the received user natural language query to a format compatible with the common indexing scheme for the visual features of the received video frames to thereby support an efficient similarity search of the vector index.

In embodiments, an alert/notification manager 260 may be provided to receive the results of the similarity search of the vector index, retrieve matching clips/frames and send alerts/results to one or more output display components (see element 160 in FIG. 1).

The above-indicated system architecture, and as will be captured in the method steps described below, include certain individual distinctions that, taken individually or in combination, render the disclosed schemes unique. The distinctions are enumerated in the following paragraphs.

Selective semantic indexing of live video content may be provided where the disclosed scheme receives video from one or more cameras and selectively indexes less than all incoming frames or regions. Instead of exhaustively storing all video content, the disclosed scheme may determine whether newly observed visual content is sufficiently distinct to merit indexing, thereby reducing redundant storage and processing load.

Partitioning of frames into regions for localized analysis may be implemented where incoming frames may be divided into multiple regions, including overlapping regions and/or regions at multiple scales, so that distinct portions of a scene may be independently evaluated for indexing. This may enable the disclosed scheme to detect localized novelty or significance even where changes are subtle or otherwise may not affect an entire frame.

Generation of visual-semantic embeddings may be provided for a given frame, region, chip, object crop or other image portion in that the disclosed scheme may compute a visual-semantic embedding using a pretrained vision-language model or other feature extraction model. Such visual-semantic embeddings may provide a machine-computable representation of scene content suitable for indexing, comparison, and retrieval.

Rolling background embedding for semantic baseline comparison may be provided in that the exemplary scheme may maintain a background representation for a frame region or class of regions, such as a rolling, average, moving-average, or otherwise updated non-redundant background embedding derived from prior observations. Newly observed content may be compared against that archived background representation to determine whether the content reflects semantic novelty relative to an ordinary state of the scene.

Combined motion gating and semantic gating may be provided such that the exemplary scheme may use one or both of physical motion detection and semantic deviation to determine whether a frame or region should be extracted and indexed. Motion detection may identify candidate changes in a particular scene, while semantic comparison may determine whether the new content is meaningfully different from a prior background state. Such a combined gate may allow the exemplary scheme to distinguish meaningful changes from repetitive or insignificant variation.

Configurable thresholding for indexing decisions may be available to assess a newly observed frame, region, or chip for indexing when its embedding differs from a stored or rolling background embedding by more than a configurable threshold. The configuration thresholds may represent, for example, cosine distance, cosine similarity, dot product difference, Euclidean distance, a learned threshold, a camera-specific threshold, a region-specific threshold, or another decision criterion.

Sparse semantic memory linked to source video may be implemented in such a manner that, rather than storing only raw video or only human-readable labels, the disclosed scheme may store selected embeddings and associate them with source video references, timestamps, camera identifiers, clip identifiers, and/or other metadata. Such a scheme may create a sparse semantic memory that preserves search-relevant content while avoiding full duplication of static or repetitive footage.

Natural-language retrieval over the selectively indexed corpus may be provided in that where a user query is provided in natural language, the query may be converted into a query embedding in the same or a corresponding semantic space as the indexed visual content. The disclosed scheme may search the selectively-stored embeddings to identify matching frames, clips, regions, or events, thereby enabling open-vocabulary retrieval over surveillance content without requiring a fixed label taxonomy.

Query-time background-aware rescoring may be provided as query results may be re-scored by comparing candidate matches not only to the query embedding but also to background embeddings, baseline embeddings, or other stored scene references. Such a scheme may have the effect of reducing instances of false positives by favoring content that is more similar to the query than to the ordinary background state of the corresponding region or scene.

Standing alerts using stored semantic conditions may be employed as a user may define one or more persistent alert conditions using natural language, example imagery, stored embeddings, or other semantic criteria. The disclosed scheme may compare newly indexed content against one or more saved alert definitions and, when a particular or pre-defined condition is met, transmit a notification, ranked result, frame, clip, or other output to a local or remote device.

Real-time and multi-camera operation may be provided as the disclosed scheme may ingest, process, index, search, and/or alert across multiple camera streams in real time or near real time. Embeddings from multiple streams may be stored in a shared semantic index or in federated indexes searchable as a unified corpus.

Reduced dependence on predefined detector classes may be implemented in that the disclosed scheme need not necessarily rely exclusively on fixed detector vocabularies, manually defined metadata schema, or repeated retraining for each new search target. By operating over a selectively indexed semantic representation, the disclosed scheme may sufficiently support retrieval of newly described objects, persons, scenes, or activities within the representational scope of the underlying models.

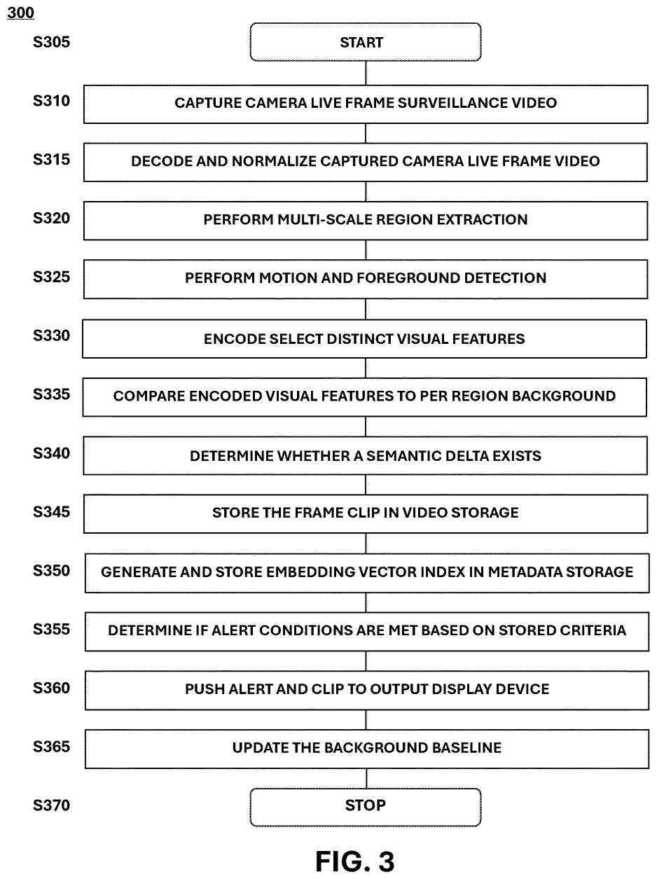

FIG. 3 schematically illustrates an exemplary embodiment of a flowchart for a method 300 that may be usable to effect elements of performing live ingest and real-time selective video indexing according this disclosure. As shown in FIG. 3, operation of the method commences at Step S305 and proceeds to Step S310.
In Step S310, camera live surveillance video may be captured from one or more connected surveillance cameras. Operation of the method proceeds to Step S315.
In Step S315, the captured live frame video may be decoded and normalized. Operation of the method proceeds to Step S320.
In Step S320, multi-scale region extraction may be performed. Operation of the method proceeds to Step S325.
In Step S325, motion and foreground detection may be performed. Operation of the method proceeds to Step S330.
In Step S330, select distinct visual features may be encoded. Operation of the method proceeds to Step S335.
In Step S335, the encoded visual features may be compared to per region background. Operation of the method proceeds to Step S340.
In Step S340, a determination may be made as to whether a semantic delta exists. Operation of the method proceeds to Step S345.
In Step S345, in instances in which Step S340 determines existence of a semantic delta, such frame clip may be stored in video storage. Operation of the method proceeds to Step S350.

Separately, in instances in which in Step S340 a determination is made thar no semantic delta exists, operation of the method bypasses Steps S345-S360 and proceeds directly to Step S365.
In Step S350, an embedding vector index associated with the semantically distinct frame clip may be generated and stored in metadata storage. Operation of the method proceeds to Step S355.
In Step S355, a determination may be made if certain alert conditions are met with respect to the semantically distinct frame clip according to stored alert criteria. Operation of the method proceeds to Step S360.
In Step S360, in instances in which a determination is made that the certain alert conditions are met in Step S355, an alert may be generated and pushed with the semantically distinct frame clip to one or more output display devices. Operation of the method proceeds to Step S365.
In Step S365, the scene (background) baseline may be updated. Such update may include one or more involved regions. Operation of the method proceeds to Step S370, here operation of the method ceases.

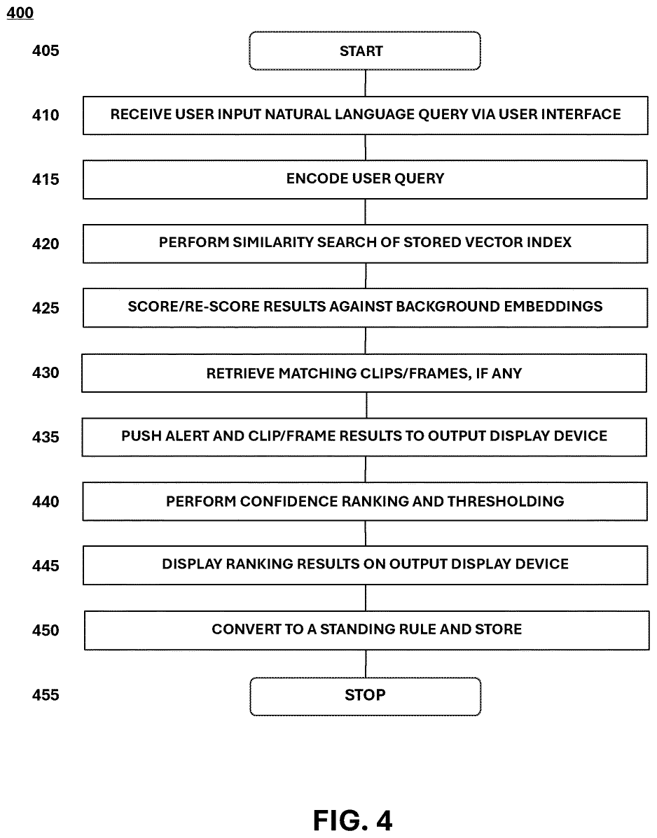

FIG. 4 schematically illustrates an exemplary embodiment of a flowchart for a method that may be usable to effect elements of performing user-initiated query, retrieval and alerting according this disclosure. As shown in FIG. 4, operation of the method commences at Step S405 and proceeds to Step S410.
In Step S410, a user input natural language query may be received via a user interface. Operation of the method proceeds to Step S415.
In Step S415, the received user query may be encoded using a substantially similar encoding scheme to that referenced above in order to render that received user query compatible with the stored vector index. Operation of the method proceeds to Step S420.
In Step S420, a similarity search of the stored vector index may be performed. Operation of the method proceeds to Step S425.
In Step S425, a result of the similarity search may be score and/or re-scored against stored background embeddings. Operation of the method proceeds to Step S430.
In Step S430, matching clips/frames, if any, may be retrieved. Operation of the method proceeds to Step S435.
In Step S435, in instances in which matching clips/frames are retrieved. an alert may be generated and pushed with the matching clips/frames to one or more output display devices. Operation of the method proceeds to Step S440.
In Step S440, confidence ranking and/or thresholding may be performed. Operation of the method proceeds to Step S445.
In Step S445, ranking (and/or thresholding) results may be displayed on one or more output display devices. Operation of the method proceeds to Step S450.
In Step S450, the new ranking (and/or thresholding) results may be converted to a new standing rule and stored. Operation of the method proceeds to Step S455, where operation of the method ceases.

As indicated above, myriad alternative implementations beyond those which may be detailed herein are contemplated to be encompassed by the details set forth in this disclosure. By way on non-limiting examples, such alternatives may include, for example:
Alternative feature extraction models—Although embodiments may use OpenCLIP or another pretrained vision-language model, as noted above, any suitable embedding model, multimodal encoder, image encoder, video encoder, transformer-based model, convolutional model, self-supervised model, or combination thereof is envisioned to be employable to carry onto effect the described feature extraction, i.e., the disclosed schemes are not limited to any specific model family.
Alternative indexing units—It should be understood that indexing may occur at the level of full frames, partial frames, overlapping regions, image chips, detected objects, segmented foreground regions, temporal windows, clips, or combinations thereof. Different units may be used for different camera types, deployments, or operating modes.
Alternative region extraction techniques—As noted briefly above, regions may be fixed, sliding, overlapping, hierarchically defined, object-driven, segmentation-driven, motion-driven, or adaptively selected. In embodiments, regions may be generated by foreground extraction, object detection, segmentation, saliency analysis, operator-defined zones, or learned region proposal methods.
Alternative motion or foreground detection schemes—Again, as noted briefly above, motion detection may include frame differencing, optical flow, RPCA or robust PCA, background subtraction, temporal differencing, depth-based motion estimation, event-based sensing, or other foreground extraction methods. While mentioned coincidentally with semantic change detection above, it should be noted that, in embodiments, motion detection may be omitted in favor of semantic change detection alone, or semantic change detection may be omitted in favor of motion (motion-first candidate selection detection alone.
Alternative background baseline generation—It should be further understood that the background representation may be formed using a moving average, exponentially weighted average, sliding time window, rolling cluster center, prototype vector, historical exemplar bank, median representation, or any other baseline derived from prior observations. Separate baselines may be maintained per region, per camera, per time of day, per environmental condition, or per detected scene state, or otherwise according to any definable discrete discriminator.
Alternative semantic change metrics—It should be additionally understood that semantic change may be determined using cosine similarity, cosine distance, dot product, Euclidean distance, Mahalanobis distance, learned novelty scores, classifier-based novelty estimation, rank-based measures, or combinations thereof. Thresholds may be static, adaptive, context-specific, user-tunable, model-tunable, or learned from observation history.
Alternative search infrastructures—As indicated above, indexed embeddings may be stored in FAISS or in any other approximate nearest-neighbor index, vector database, hybrid vector-relational database, key-value store, distributed search engine, or cloud-hosted retrieval service. Exact nearest-neighbor search may also be used. The disclosed schemes are not limited to any particular database product or index structure.
Alternative query modalities—Albeit that it is anticipated that queries may generally be provided as natural language queries, this does not restrict queries that may be in a form of, or otherwise employ, one or more of the following: keywords, structured text, example images, example clips, saved embeddings, and alert rules. In embodiments, a text query may be combined with metadata filters such as, for example, camera ID, time range, site, location, or event window.
Alternative result ranking approaches—Retrieved candidates may be ranked by vector similarity alone, by vector similarity plus background-aware rescoring, by temporal coherence, by metadata confidence, by camera priority, by alert urgency, or by operator feedback. Any re-ranking may occur locally, centrally, or in a hybrid fashion.
Alternative deployment topologies—Processing may occur on-camera, on an edge appliance, on a video extraction unit, on a local server, in a cloud environment, or in a federated combination of these. Embeddings may be computed near the source camera and searched centrally, or both indexing and search may be distributed.
Alternative alerting embodiments—Alerts may be triggered by one-time user queries, persistent saved queries, semantic similarity thresholds, combinations of semantic and metadata conditions, or operator-defined workflow rules. Alert outputs may include local display updates, push notifications, text messages, emails, API calls, webhook triggers, remote device notifications, automated clip generation, and the like.
Alternative model update strategies—While embodiments may rely substantially on pretrained zero-shot capability without retraining. optional fine-tuning, calibration, threshold adjustment, user feedback loops, or domain adaptation while retaining the core selective semantic indexing architecture, may be used.
Alternative storage relationships—As indicated above, no particular configurations for data storage are intended by the open=ended description provided. For example, source video may be stored in full, selectively, or on a rolling basis on any manner of internal or external video storage device or medium. Likewise with indexed embeddings that may, for example, varyingly reference source clips without duplicating the entire video, or may be stored together with cropped imagery, thumbnails, event summaries, or operator annotations.
Alternative multi-camera correlation embodiments—Disclosed multi-camera operation may be understood as encompassing one or more of a unified shared embedding space, separate per-camera spaces with translated comparisons, site-specific indexes, cross-site federated search, or correlation of visually similar objects across distinct viewpoints and streams.

In short, all combinations and variations of the disclosed structures are available and encompassed by this disclosure.

The above-described exemplary systems, methods, applications, techniques, schemes and potential real-world use cases are intended to provide a brief, general description of suitable operating and integration environments in which the subject matter of this disclosure may be implemented for familiarity and ease of understanding.

Those skilled in the fields of endeavor generally surrounding video surveillance, including with regard to video capture, storage, search and alerting will likely appreciate that other embodiments of the disclosed subject matter may be practiced in many systems, methods, applications, techniques, schemes, and related use cases, including various dtat processing components for carrying into effect the disclosed inventive concepts substantially in the manner described above or otherwise.

The exemplary depicted sequence of method steps represents one example of a corresponding sequence of acts for implementing the functions described in the steps of the above-outlined exemplary method. The exemplary depicted steps may be executed in any reasonable order to carry into effect the objectives of the disclosed embodiments. No particular order to the disclosed steps of the method is necessarily implied by the depictions in FIGS. 3 and 4, except where a particular method step is reasonably a necessary precondition to execution of any other method step.

Those of skill in the art may recognize that particular embodiments according to the disclosed systems, methods, applications, techniques and schemes may find utility in areas other than those described in detail above. As indicated above, no particular configuration should be read into the description of the exemplary disclosed embodiments, nor should any coincident use case for the disclosed subject matter be discounted.

The disclosed systems, methods, applications, techniques and schemes represent particular improvements upon the currently available video capture and indexing schemes. That said, other ancillary benefits may be recognized and achieved through implementation and/or extended use of the disclosed schemes. The scope of the known, potential and yet-to-be discovered advantages is boundless.

Specific reference to the above-discussed embodiments, and specified characteristics of the exemplary embodiments, should not be interpreted to constrain the disclosed systems, methods, applications, techniques and schemes to only those embodiments. The depicted and described embodiments are included for non-limiting illustration of the disclosed concepts for implementing these systems, methods, applications, techniques and schemes. All of the above depictions and/or descriptions should, therefore, be interpreted as being exemplary only, and not limiting the disclosed schemes, in any manner.

Features and advantages of the disclosed embodiments are set forth in this disclosure and may be, at least in part, obvious from this detailed description or may be learned by practice of the disclosed embodiments. The features and advantages of the disclosed embodiments may be realized and obtained by means of the instruments and combinations of features particularly described.

Various embodiments of the disclosed systems, methods, applications, techniques and schemes are discussed in this disclosure. While specific implementations are discussed, it should be understood that this is done for illustration purposes only. A person skilled in the relevant art will recognize that other configurations may be used without departing from the spirit and scope of the disclosed embodiments.

We claim:

1. A system for real time video indexing and search, comprising:
a video surveillance camera;
a user interface;
a data storage component;
an output display device; and
a processor in communication with the video surveillance camera, the user interface, the data storage component and the output display device, the processor being configured to:
capture live frame surveillance video in a feed from the video surveillance camera;
at least one of decode and normalize a frame of the captured live frame surveillance video;
encode select visual features in the at least one of the decoded and normalized frame;
compare the encoded select visual features to a stored scene baseline to determine if a difference exists in the at least one of the decoded and normalized frame;
store the at least one of the decoded and normalized frame in the data storage component only in instances in which the difference is determined to exist;
generate indexing information for the stored at least one of the decoded and normalized frame according to an indexing scheme; and
store the indexing information associated with the stored at least one of the decoded and normalized frame separately in a vector index in the data storage component.

2. The system of claim 1, the processor being further configured to parse the at least one of the decoded and normalized frame into a number of discrete regions, the encoding and comparing being applied on a region by region basis.

3. The system of claim 1, the stored scene baseline being a stored background baseline and the encoded select visual features being one or more foreground features, the difference representing a semantic difference therebetween.

4. The system of claim 1, the encoded select visual features being detected movement.

5. The system of claim 1, the processor being further configured to:
reference a stored set of automated alert conditions to determine if any stored automated alert condition is met; and
when it is determined that one or more automated alert condition is met to:
generate an automated alert message; and
push the automated alert message and the at least one of the decoded and normalized frame for display on the output display device.

6. The system of claim 1, the processor being further configured to update the stored scene baseline.

7. The system of claim 1, the processor being further configured to:
receive a query from a user via the user interface;
encode the received user query using the indexing scheme;
perform a similarity search of the vector index based on the encoded query to determine if any of the stored frames are responsive to the query; and
push the stored frames responsive to the query for display on the output display device.

8. The system of claim 7, the processor being further configured to:
generate an alert message responsive to the query; and
push the alert message with the stored frames responsive to the query for display on the output display device.

9. The system of claim 7, the processor being further configured to at least one of score and re-score a result of the similarity search against background embeddings.

10. The system of claim 7, the processor being further configured to perform at least one of confidence ranking and thresholding of a result of the similarity search.

11. The system of claim 10, the processor being further configured to output a result of the at least one of confidence ranking and thresholding for display on the output display device.

12. The system of claim 10, the processor being further configured to convert a result of the at least one of confidence ranking and thresholding to a standing rule to be stored in the data storage component.

13. The system of claim 1, wherein the user interface and the output display device are integral to a user mobile device.

14. A method for real time video indexing and search, comprising:
capturing live frame surveillance video in a feed from a video surveillance camera;
at least one of decoding and normalizing a frame of the captured live frame surveillance video;
encoding select visual features in the at least one of the decoded and normalized frame;
comparing the encoded select visual features to a stored scene baseline to determine if a difference exists in the at least one of the decoded and normalized frame;
storing the at least one of the decoded and normalized frame in the data storage component only in instances in which the difference is determined to exist;
generating indexing information for the stored at least one of the decoded and normalized frame according to an indexing scheme; and
storing the indexing information associated with the stored at least one of the decoded and normalized frame separately in a vector index in the data storage component.

15. The method of claim 14, further comprising parsing the at least one of the decoded and normalized frame into a number of discrete regions, wherein the encoding and comparing steps are applied on a region by region basis.

16. The method of claim 14, the stored scene baseline being a stored background baseline and the encoded select visual features being one or more foreground features, the difference representing a semantic difference therebetween.

17. The method of claim 14, the encoded select visual features being detected movement.

18. The method of claim 14, further comprising referencing a stored set of automated alert conditions to determine if any stored automated alert condition is met, and when it is determined that one or more automated alert condition is met:
generating an automated alert message; and
pushing the automated alert message and the at least one of the decoded and normalized frame for display on an output display device.

19. The method of claim 14, further comprising updating the stored scene baseline.

20. The method of claim 14, further comprising:
receiving a query from a user via a user interface;
encoding the received user query using the indexing scheme;
performing a similarity search of the vector index based on the encoded query to determine if any of the stored frames are responsive to the query; and
pushing the stored frames responsive to the query for display on an output display device.

21. The method of claim 20, further comprising:
generating an alert message responsive to the query; and
pushing the alert message with the stored frames responsive to the query for display on the output display device.

22. The method of claim 20, further comprising at least one of scoring and re-scoring a result of the similarity search against background embeddings.

23. The method of claim 20, further comprising performing at least one of confidence ranking and thresholding of a result of the similarity search.

24. The method of claim 23, further comprising outputting a result of the at least one of confidence ranking and thresholding for display on the output display device.

25. The method of claim 23, further comprising:
converting a result of the at least one of confidence ranking and thresholding to a standing rule; and
storing the standing rule in the data storage component.
